(19) United States
(12) Patent Application Publication
(10) Pub. No.: US 2015/0226368 A1
(43) Pub. Date: Aug. 13, 2015

(54) Insulated Tube Joint Connection

(71) Applicants: Rob Schellin, Stoughton, WI (US); Jason Drost, Lake Mills, WI (US); Scott Lubenow, Fitchburg, WI (US); Nathaniel Derks, Madison, WI (US); Shane O'Rourke, Oregon, WI (US); Eric Miller, Madison, WI (US)

(72) Inventors: Rob Schellin, Stoughton, WI (US); Jason Drost, Lake Mills, WI (US); Scott Lubenow, Fitchburg, WI (US); Nathaniel Derks, Madison, WI (US); Shane O'Rourke, Oregon, WI (US); Eric Miller, Madison, WI (US)

(73) Assignee: NELSON GLOBAL PRODUCTS, Stoughton, WI (US)

(21) Appl. No.: 14/179,429

(22) Filed: Feb. 12, 2014

(51) Int. Cl. F16L 59/18; F16L 23/12; F16L 23/16; F16L 23/04

(52) U.S. Cl. CPC F16L 59/184; F16L 23/04; F16L 23/12; F16L 23/162

(57) ABSTRACT

An insulated tube joint connection having a tube with an end portion, a load transfer rim joined to and extending radially outwardly from the tube, and a clamping seat joined to the load transfer rim and spaced apart from the tube end portion to at least partially define an insulation space.

### FIELD AND BACKGROUND OF THE INVENTION

This invention relates generally to tubes through which high temperature gases flow, and more particularly to an insulated tube joint connection.

Vehicles of many types use tubes to transfer exhaust gases from an engine to mufflers or aftertreatment components such as catalytic converters, heat exchangers, or other downstream elements. Optimum treatment of the exhaust gases in the aftertreatment device can depend on the gases being at a relatively high gas temperature, so it is preferred to minimize heat loss between the engine and the aftertreatment device.

To minimize heat loss, tubes between the engine and the aftertreatment device are kept to a minimum length, are at least partially insulated, and use as few segments as possible to minimize uninsulated tube joints. Various attempts have been made to insulate exhaust tubes. For example, some insulated tube systems have rigid tubes joined by clamps that carry and transfer loads from one tube section to another. Insulation is applied to an outer surface of a tube and then the insulation is wrapped in a 16 to 18 gauge metal, a light-weight metal, a silicon wrap, a sewn blanket, or other methods.

This arrangement is adequate for most of the tube, but tube end portions with clamp seats are not insulated because the clamps and clamp seats are attached to the ends of adjacent tube sections. Such connectors are sturdy and effectively transfer loads from one tube section to another, but the location and size of the clamp seats and clamp make insulating the end portions of the tubes difficult, and result in a significant loss of heat at the connection even though most other portions of the tubes have exterior insulation. Further, with an uninsulated joint, the clamp temperature can be very high when exhaust gases are flowing. Examples of such clamp arrangements are disclosed in Drost et al., U.S. Publ. 2011/0074150 A1 and Matthis et al., U.S. Pat. No. 8,328,243. Some attempts have been made to wrap connections in insulating material, but the wraps must be removed to work on the joint and the wraps are secured using springs, for example, so they can loosen during use. With the insulation on the outside of the clamp, the clamp can get quite hot and be difficult to maintain.

Other exhaust systems use complex and expensive double-walled exhaust pipes. Numerous problems arise with double-walled pipe due to differential movement of inner and outer pipe walls, as well as heat damage at locations where the inner and outer pipe are connected. Other problems arise from hot gases interacting with the inner tubes of the double-walled systems.

For example, Weber, U.S. Pat. No. 2,423,213 discloses an insulating pipe having a high temperature inner conduit that includes an outer shell spaced apart from an inner conduit. The outer shell is relatively rigid and can include clamping flanges for joining adjacent sections of shells. The inner conduit defines the passage for hot gases, is made of heat resistant materials, and includes vent holes and stiffener rings to accommodate hot and pressurized gas. At the connection or joint between adjacent sections of inner conduit, an inner sleeve is necessary to ensure gases flow efficiently from one pipe section to another. Loads from one pipe section to another are carried by the outer shell, but no loads are transferred between adjacent sections of inner conduits. The resulting pipe system is expensive and difficult to maintain. See also: Yanazaki et al., U.S. Pat. No. 4,031,700; Kaiko et al., U.S. Pat. No. 5,953,912.

An insulated exhaust pipe connection is disclosed in Janle, U.S. Pat. No. 3,819,208. This connection secures adjacent pipe manifold reactor sections using outer pipes and housings. Inner liners are used to channel exhaust, but all of the insulating space is inside of the outer pipes and housings. This is inefficient and expensive to construct, assemble, and maintain.

U.S. Pat. No. 5,606,857 to Harada is similar to Janle and Weber because it provides inner insulating conduits surrounded by more rigid pipes that are joined together to carry loads from one pipe section to another. Rather than attempting to restrain these loads, Harada uses sleeves and bellows to accommodate differential movement of inner and outer pipes. See also: Kern, U.S. Pat. No. 3,864,909.

Thus, there is a need for an insulated tube joint that avoids the shortcomings described above and, yet, is simple and effective to implement.

### SUMMARY OF THE INVENTION

The present invention is related to a pipe connection that is insulated and yet provides strength, durability, ease of construction, ease of assembly with adjacent pipe sections, and is adaptable to many types of connectors.

The present invention for an insulated tube joint connection includes: a first tube defining a fluid conduit and having first end portion; a first load transfer rim joined to the first tube to at least partially define the first tube end portion; and a first outer seal clamp seat joined to the first load transfer rim and spaced radially outwardly and apart from the first tube end portion to at least partially define a first insulating space. The first end portion can include a female or male end for mating with an adjacent tube to form an inner tube connection. The insulated tube joint can also include insulation disposed in the insulating space.

The first load transfer rim can be substantially channel-shaped in cross section, arcuate in cross section, a tapering in cross section or have any other suitable shape and dimension to transfer loads from one tube section to another. Similarly, the outer seal clamp seat can have any suitable shape, size or orientation that satisfies the criteria of joining adjacent pipe sections, transferring the required loads, and insulating as described herein. For example, the outer clamp seal can extend radially outwardly from the tube or it can be substantially parallel to the first tube. The first outer seal clamp seat can include a resilient wall that flexes and is closed when clamping pressure is applied. The insulated tube joint connection first outer seal clamp seat can include an annular wall defining a longitudinal groove for clamping movement between a clamped partially closed position and an unclamped open position. The insulated tube joint connection tube, load transfer rim, and outer seal clamp seat can also be formed integrally with one another or they can be made as separate parts and assembled.

The insulated tube joint connection can further include a second tube defining a conduit and having a second tube end portion adjacent to the first tube end portion of the first tube; a second load transfer rim joined to the second tube to at least partially define the second tube end portion; and a second outer seal clamp seat joined to the second inner seal spacer and spaced radially outwardly from the second tube end portion to at least partially define a second insulating space. Insulation can be disposed in the second insulating space. When clamped, the first outer seal clamp seat is in mating contact with the second outer seal clamp seat. The second tube end portion can be disposed for movement relative to the first tube end portion; and the first outer seal clamp seat and the second outer seal clamp seat include complimentary flared, ramped or flange portions for movement between a clamped position and an unclamped position.

Also within the scope of the invention is an insulated tube joint retrofitting connection having a first load transfer rim having a base portion to be joined to a first tube and disposed to at least partially define a first tube end portion on the first tube; and a first outer seal clamp seat joined to the first load transfer rim and spaced apart radially outwardly and apart from the first load transfer base portion to at least partially define a first insulating space. The retrofitted insulated tube joint can have all of the same features as one originally manufactured with the joint components.

### BRIEF DESCRIPTION OF THE DRAWINGS

FIG. 1a is a perspective view of an insulated tube joint connector in accordance with the present invention;

FIG. 1b is an end view of the insulated tube joint connector in FIG. 1a;

FIG. 1c is a cross-sectional view of the insulated tube joint connector taken along line 1c-1c in FIG. 1b;

FIG. 2a is a partial cross-sectional view of an alternate tube joint in accordance with the present invention;

FIG. 2b is a partial cross-sectional view of an alternate tube joint in accordance with the present invention;

FIG. 3a is a partial cross-sectional view of alternate load transfer rims in accordance with the present invention;

FIG. 3b is a partial cross-sectional view of alternate load transfer rims in accordance with the present invention;

FIG. 4a is a cross-sectional view of an insulated tube joint connection with alternate clamp seats in accordance with the present invention;

FIG. 4b is a cross-sectional view of an insulated tube joint connection with alternate clamp seats in accordance with the present invention;

FIG. 4c is a cross-sectional view of an insulated tube joint connection with alternate clamp seats in accordance with the present invention;

FIG. 4d is a cross-sectional view of an insulated tube joint connection with alternate clamp seats in accordance with the present invention;

FIG. 4e is a cross-sectional view of an insulated tube joint connection with alternate clamp seats in accordance with the present invention;

FIG. 4f is a cross-sectional view of an insulated tube joint connection with alternate clamp seats in accordance with the present invention;

FIG. 4g is a cross-sectional view of an insulated tube joint connection with alternate clamp seats in accordance with the present invention;

FIG. 4h is a cross-sectional view of an insulated tube joint connection with alternate clamp seats in accordance with the present invention;

FIG. 4i is a partial perspective view of the clamp seat in FIG. 4g; and

FIG. 4j is a partial perspective view of the clamp seat in FIG. 4h.

### DETAILED DESCRIPTION OF THE INVENTION

In the following detailed description of the invention, the same reference numerals will be used to identify the same or similar elements in each of the figures, unless otherwise noted.

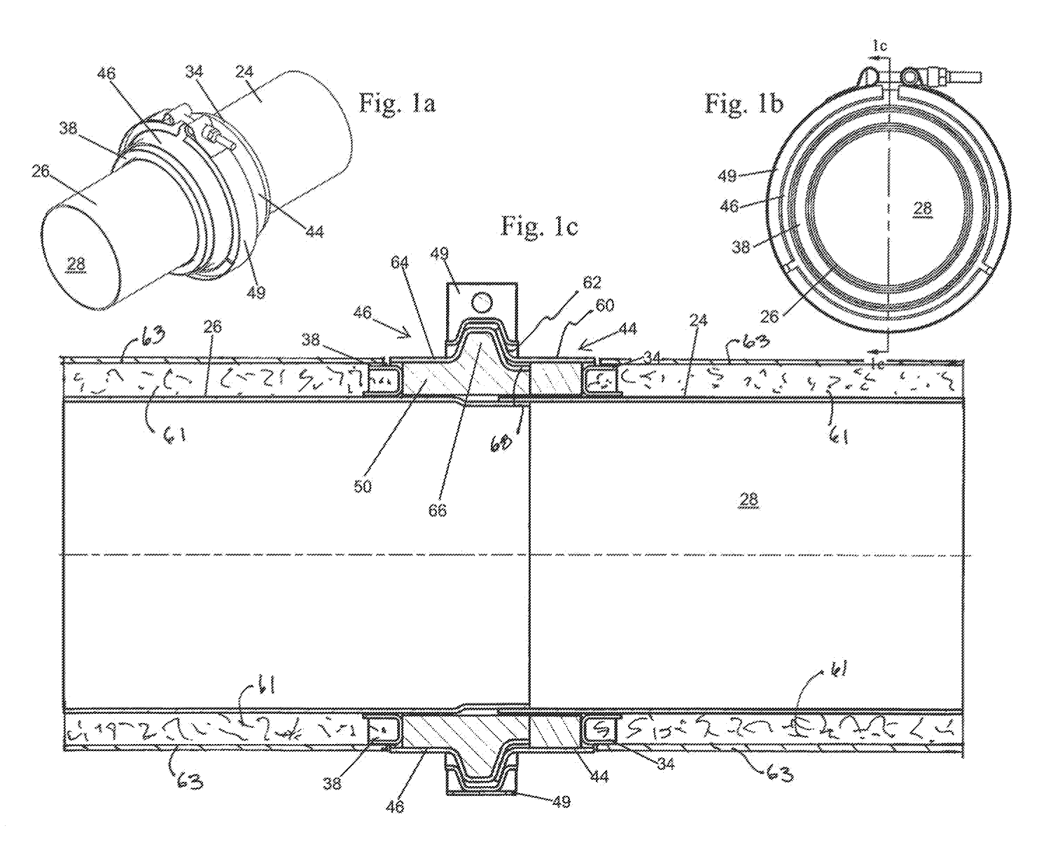

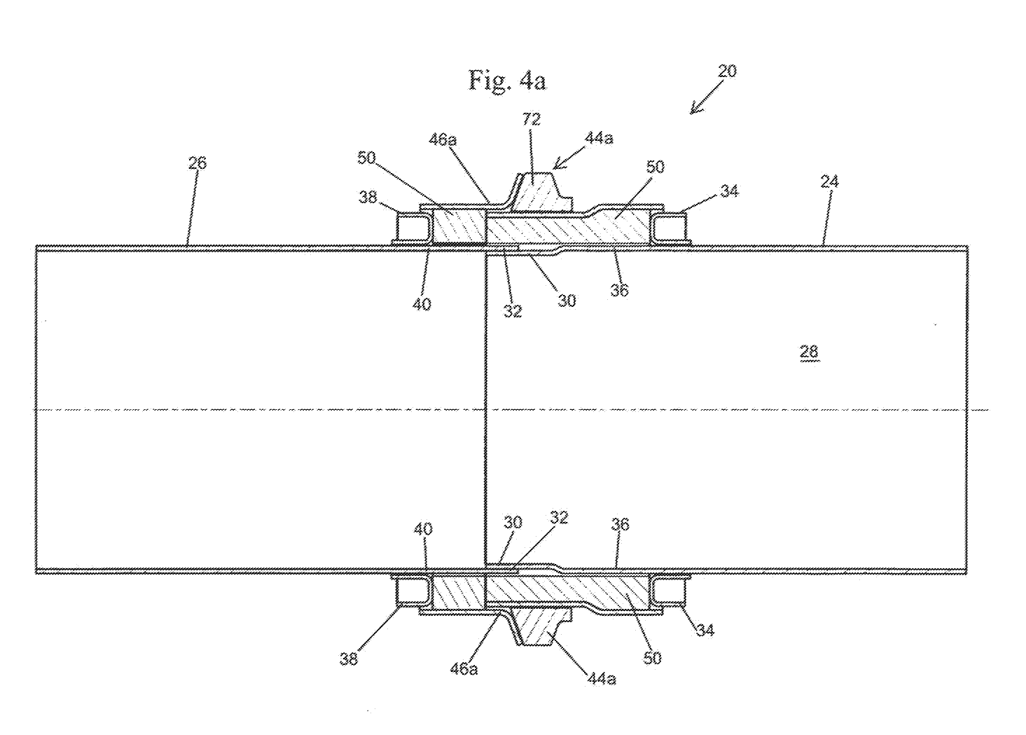

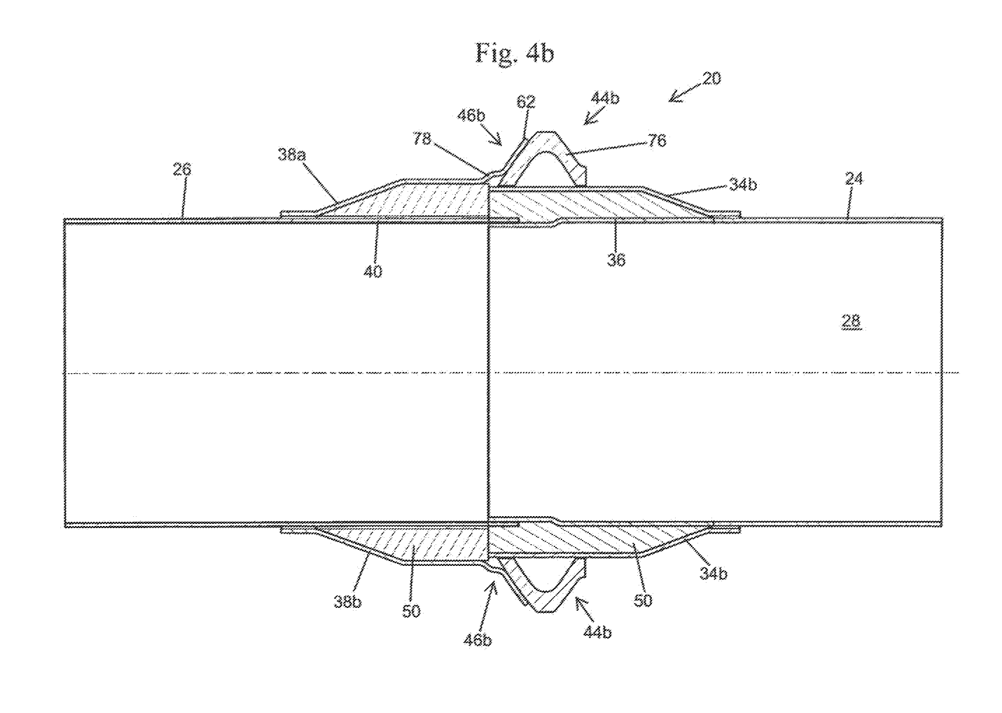

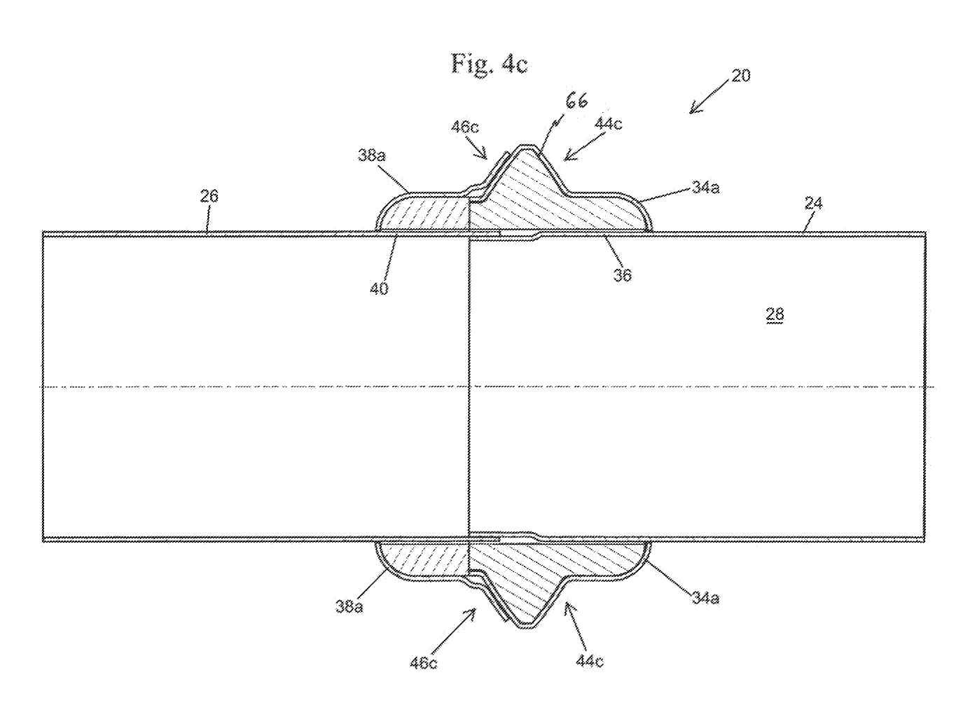

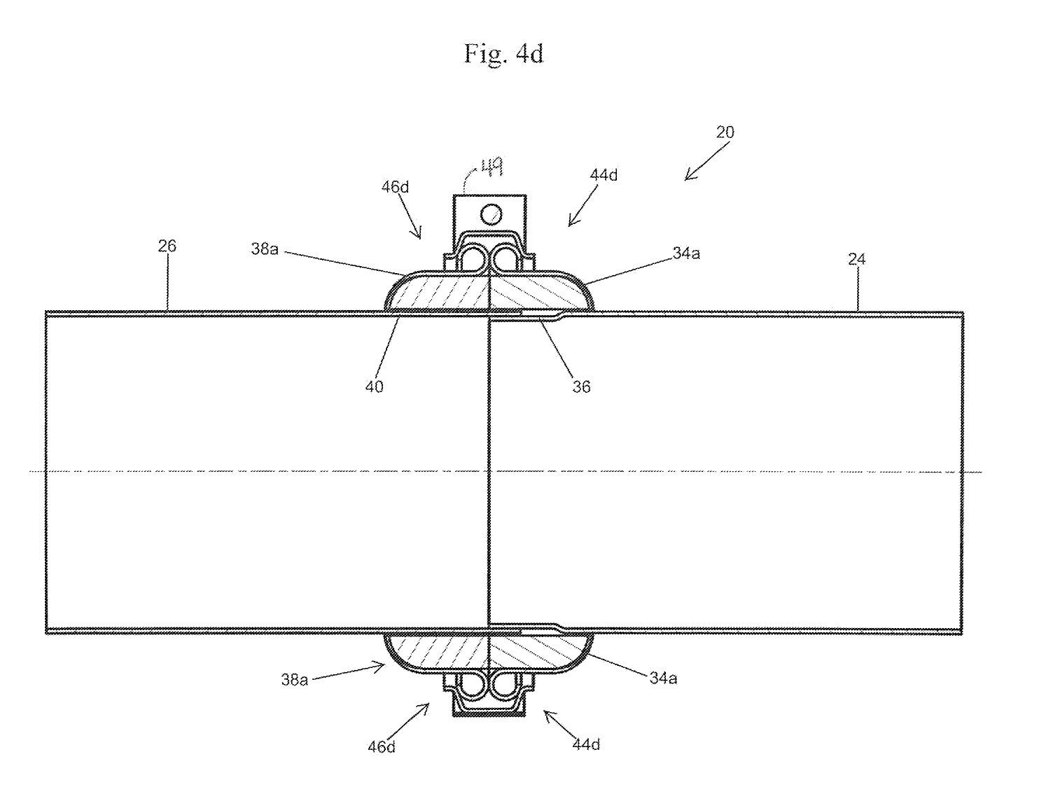

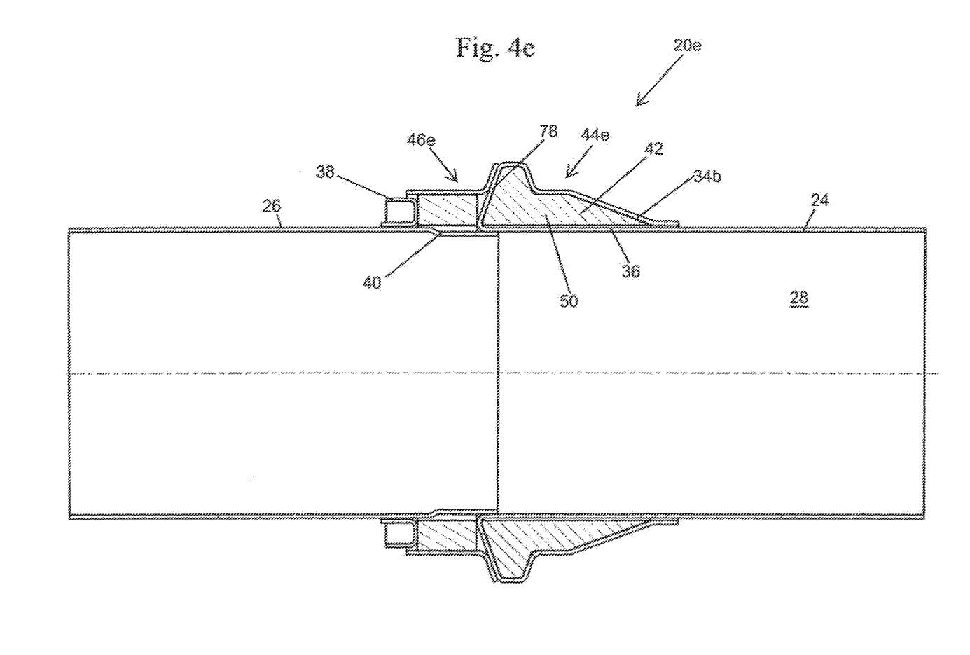

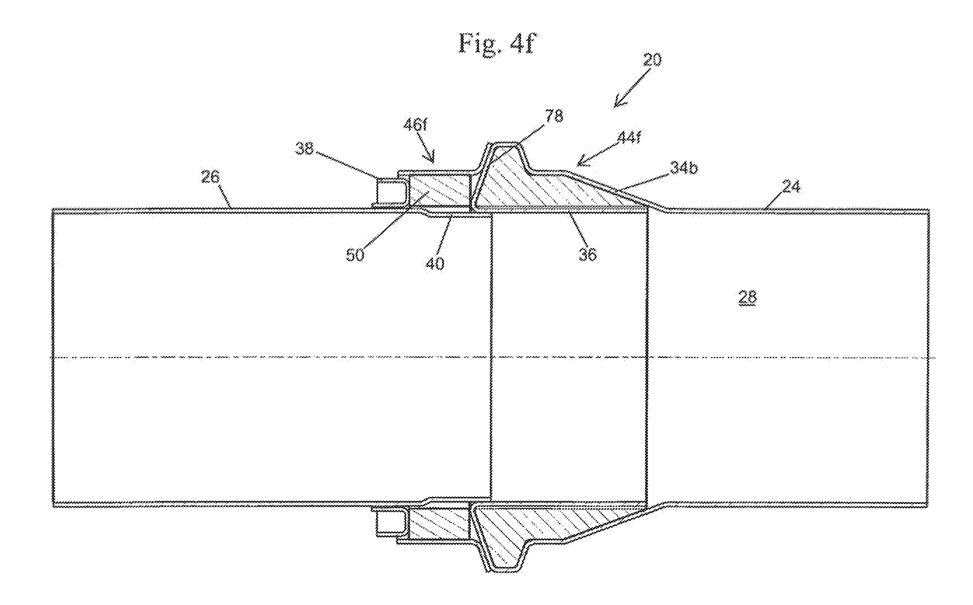

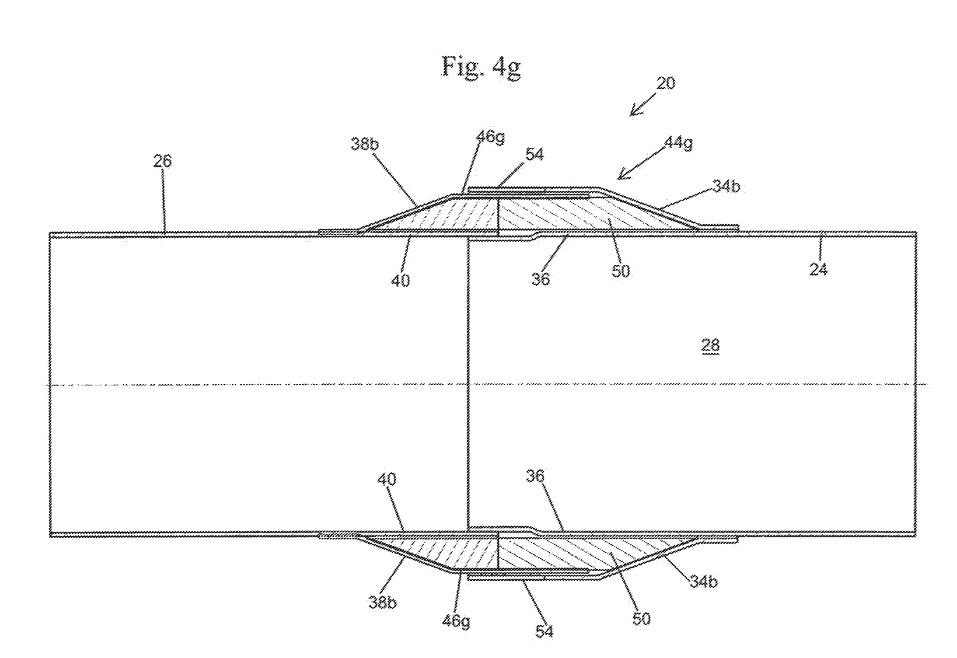

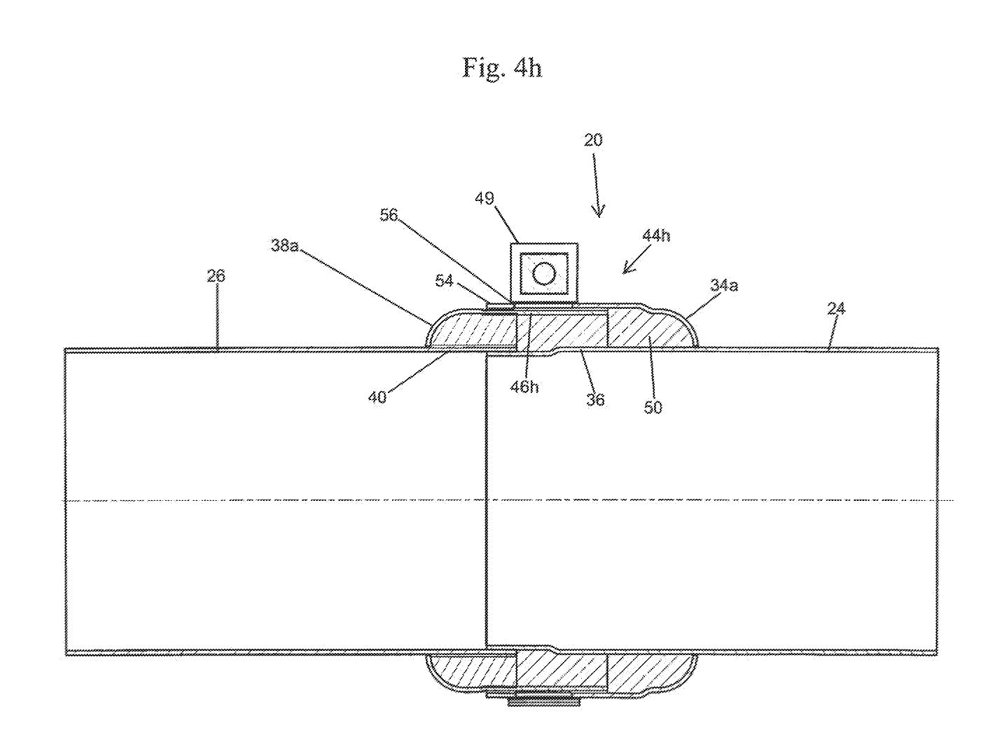

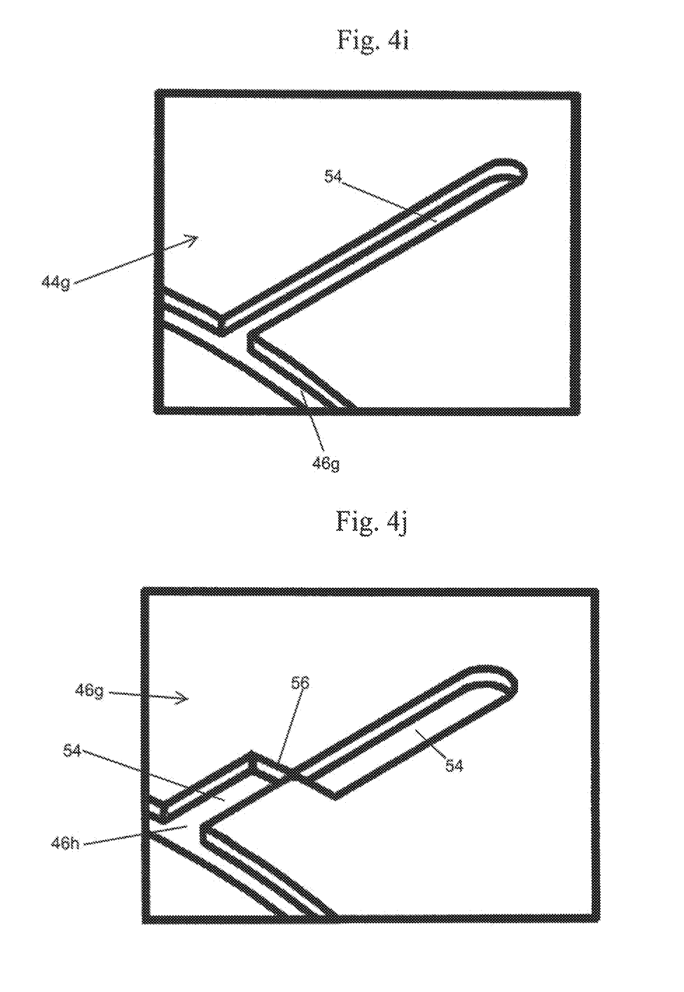

Illustrated generally in FIGS. 1a through 1c, and 4a through 4h is an insulated tube joint connection 20 including a first tube 24 and a second tube 26 that are joined together to define a conduit 28 through which relatively high temperature exhaust gases flow from an internal combustion engine to an exhaust aftertreatment device, heat exchangers, or other downstream elements. The engine and exhaust aftertreatment devices are not illustrated in detail, but either or both of the illustrated first tube 24 and the second tube 26 could be a part of or joined to an engine or exhaust aftertreatment device or they can be separate tube sections.

The terms “first” and “second” are used herein for ease of reference only and are not intended to be limited to upstream or downstream tubes and components. Further, additional tubes and tube sections can be used, so the invention and claims are not to be limited to only first and second pipes and connection components because other tube sections can be included. It is also contemplated that a single tube section can have appropriate components of both the first and second connector portions on opposite ends of the tube section.

As an example, the first tube 24 is illustrated as a downstream component and the second tube 26 is illustrated as the upstream component with exhaust gases flowing from left to right. The tubes 24 and 26 can be made of any suitable material such as mild steel, stainless steel, aluminum, for example and treated or coated with any desired material such as ceramics. The term “tube” as used herein includes tubes, pipes, conduits, or other hollow member through which hot gas flows. The tubes can be straight or curved, rigid or flexible, such as the type including a bellows.

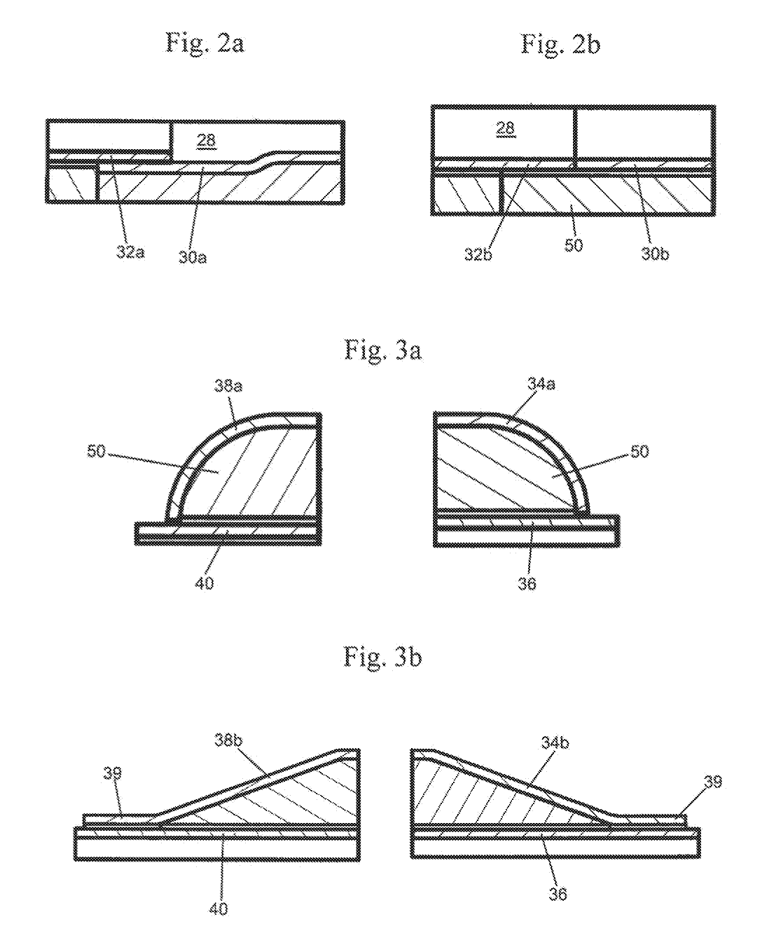

There are three optional arrangements of tube ends 30 and 32 illustrated in the drawings, but other arrangements can be used. In FIG. 1c, for example, the second tube 26 end 32 has a slightly reduced cross-sectional diameter and is inserted into a first end 30 of the first tube 24. Of course, the opposite arrangement is possible, and as seen in FIG. 2a, it is also possible to maintain the diameter of the first end 30a and slightly enlarge the diameter of the second end 32a. As another option in FIG. 2b, the first end 30b and the second end 32b have the same diameter, and be arranged in a simple butt joint.

Referring to FIGS. 1a through 1c, 3a, 3b, and 4a through 4h, the insulated tube joint connection 20 also includes a first load transfer rim 34 joined to the first tube 24 at a distance from the first end 30 to at least partially define a first tube end portion 36, and a second load transfer rim 38 joined to the second tube 26 at a distance from the second end 32 to define a second tube end portion 40. The lengths of the first tube end portion 36 and the second end tube portion 40 need not be the same (see FIGS. 4e and 4f, for example), but instead are selected to provide adequate spacing for the connector type used to join the first tube 24 to the second tube 26.

The first load transferring rim 34 and the second load transferring rim 38 preferably extend continuously around their respective tubes 24 and 26, but they can be discontinuous and sized, numbered, and spaced to any extent that is necessary to transfer axial, bending, or torsional loads between the first tube 24 the second tube 26, and their related clamp components as described below.

The illustrated load transfer rims 34 and 38 extend radially outwardly from their respective tubes 24 and 26 to a distance that at least partially defines a joint insulation space 42 for the joint connection 20. The radial dimension of the joint insulating space 42 can be any size, but is usually limited by cost, its useful insulating benefit, space, and other design criteria.

Preferably, the load transfer rims 34 and 38 are welded to their respective tubes 24 and 26, but any suitable connecting mechanism can be used including bolts, screws, rivets, clips, adhesives, and clamps that can be used to releasably join a load transfer rim to a tube. This latter feature is desirable in retrofitting an existing tube with a load transfer rim and the other components described below. The load transfer rims 34 and 38 are preferably made of stainless steel, mild steel, and aluminum, for example but any heat resistant material robust enough to transfer the necessary loads can be used.

Various configurations of the load transfer rims 34 and 38 are possible, including channel-shaped 34 and 38 in FIGS. 1c, and 4a, 4e, 4f, arcuate items 34a and 38a in FIGS. 3a, and 4c, 4d, and 4h, and flared, ramped (or tapered) items 34b and 38b in FIGS. 3b and 4b, 4e, 4f, and 4g, although other shapes can be used as well. Further, the combinations of shapes and styles of load transfer rims need not be the same as illustrated in the figures. Indeed, they can be chosen to accommodate any design criteria. Further, the ramped load transfer rims 34b and 38b are illustrated as including a base 39 that can be useful to secure the load transfer rims to the tubes in retrofit situations. Bases can also be used with other rim shapes, as well.

As illustrated in FIG. 1c, tube insulation 61 extending away from the joint can be secured to the load transfer rims 34 and 38. For example, thin foil 63 with insulation 61 can be taped, glued, welded, clamped, pressure fit, ridge locked, screwed or otherwise secured to the load transfer rims 34 and 38 as a convenient anchoring location and to make the insulation substantially continuous for the length of the tube. This feature is illustrated in FIG. 1c, and it is preferably used with all the embodiments herein, but it is not illustrated in all embodiments.

Joined to the first load transfer rim 34 is a first outer seal clamp seat 44, and joined to the second load transfer rim 38 is a second outer seal clamp seat 46. The first outer seal clamp seat 44 and the second outer seal clamp seat 46 are preferably shaped and sized to mate with one another and to be secured by an appropriate clamp 49. A clamp is not depicted in all of the drawings for simplicity, but all of the depicted embodiments would all include one in an assembled state.

The clamp seats 44 and 46 are joined to their respective load transfer rims 34 and 38 using any suitable mechanism including welds, bolts, screws, adhesives, ridge lock mechanisms, pressure fits, and clamps, for example. These parts can also be formed integrally with one another, as well as, their respective tube section as illustrated in FIGS. 4e and 4f, for example.

The clamp seats 44 and 46 are spaced radially outwardly and apart from their respective load transferring rims 34 and 38 to at least partially define the joint insulating space 42, which is preferably at least partially filled with an insulator material 50. The insulator 50 can be made of fiberglass, ceramic fibers, other materials and combinations of materials, it can fill the most, if not all, of the joint insulating space 42, and it can be inserted during manufacture of the tube section or during assembly of the tubes.

The figures illustrate at least seven different clamp seat configurations including spherical flange joint connector such as a Marmon connector FIGS. 1a, 1b, 1c, 4a, 4b, 4c, 4e, and 4f, rolled half Marmon FIG. 4d, slotted FIGS. 4g and 4i, and Torca slotted FIGS. 4h and 4j.

The first seal clamp seat 44 in FIG. 1c includes a horizontal tubular portion 60 and a radially and outwardly extending flared ramp or flange 62. The second seal clamp seat 46 in FIG. 1c also includes a horizontal tubular portion 64, an inwardly opening channel-shaped portion 66, and another horizontal portion 68, as depicted. The ramp 62 mates with the channel-shaped portion 66, and a clamp 49 secures the parts together.

The seal clamp seats 44a and 46a in FIG. 4a are similar to those in FIG. 1, but are reversed. Further, the channel-shaped portion 66 is replaced with a tapered ring 72. Similarly, in FIG. 4b, the tapered ring 72 is replaced by a tapered channel 76. The second seal clamp seat 46b further includes a crease 78 that adds flexibility and pretensions the ramp flange 62 for an improved seal. FIG. 4c illustrates similar first and second seal clamp seats 44c and 46c.

FIG. 4d illustrates first and second seal clamp seats 44d and 46d, respectively that are rolled rims to be secured together with a clamp 49.

FIG. 4e illustrates first and second seal clamp seats 44e and 46e, respectively that are similar to those described above, except that the first seal clamp seat 44e includes an end face 78 and the material is formed to extend away from the first tube end 24 to also form the ramped load transfer rim 34b. It should be understood that the end face 78 also transfers some or all of the loads and could be referred to as a load transferring rim in this embodiment. This first seal clamp seat 44e substantially encloses that portion of the joint insulation space 42, so insulation can be added during formation of the tube or injected through holes (not illustrated).

FIG. 4f illustrates and embodiment that is similar to the embodiment of FIG. 4e, except that the tube material is rolled inwardly to form the same components of the first seal clamp seat 44f.

In FIGS. 1a, 1b, 1c, and 4a through 4f, the first and second clamp seats 44 and 46 extend radially outwardly from their respective tubes 24 and 26. In FIGS. 4g and 4h, however, the first and second clamp seats 44g, 44h and 46g, 44h, respectively, are substantially cylindrical and coaxial with the tubes 24 and 26. Other arrangements are possible to accommodate the insulation needs of the joint connection.

In FIG. 4g, for example, the first clamp seat 44g is made to be at least partially resilient by including a longitudinal slot 54 that is wrapped by an annular and radially constricting clamp (not illustrated) and squeezed from the open position (illustrated in FIG. 4i) to an at least partially closed position. FIGS. 4h and 4j illustrate a similar arrangement to FIGS. 4g and 4i, except that the longitudinal slot 54 is staggered with a radial step 56 to aid in resisting the lateral loads on the first tube 24 when the clamp 49 is closed.

Due to the outwardly radially spaced clamp seats 44 and 46, the resulting insulated tube joint connector 20 is larger in diameter than a joint connector that is applied directly to the tubes 24 and 26. A larger joint connector 20 is better able to resist loads, is less susceptible to fatigue failure, and is simple to connect during assembly and repair of the vehicles on which it will be mounted. Further, the clamp is less susceptible to heat damage because it is insulated from the hot exhaust gas in the tubes. Consequently, it can be easier to handle and maintain.

To obtain some of the benefits of the present invention, it is only necessary to use the connector features on one side of the tube connection. In such cases, only half on the joint connection will be insulated as described herein, and the clamp or the clamp seat on the adjacent tube section will be sized, selected or modified to mate with the insulated side of the joint in accordance with the present invention.

The insulated tube joint connector 20 is also adaptable to existing exhaust tubes by simply adding a load transmission rim with a clamp seat to a tube by welding, pressure fit, compression clamp or any other suitable mechanism, using a larger diameter clamp for engaging adjacent clamp seats. The existing clamp seats, if any, can be removed or left in place for the retrofit. Thus, due to its simplified construction, the present invention is available for newly manufactured components as well as in retrofit situations with one or both tube segments being retrofitted.

The foregoing detailed description of drawings is provided for understanding details and benefits of the invention only, and no unnecessary limitations therefrom should be read into the following claims.

1. An insulated tube joint connection comprising:
a first tube defining a fluid conduit and having first end portion;
a first load transfer rim joined to the first tube to at least partially define the first tube end portion; and
a first outer seal clamp seat joined to the first load transfer rim and spaced radially outwardly and apart from the first tube end portion to at least partially define a first insulating space.

2. The insulated tube joint connection of claim 1, wherein the first tube, the first load transfer rim, and the first outer seal clamp seat are formed integrally with one another.

3. The insulated tube joint connection of claim 1, wherein the first end portion includes a female tube end.

4. The insulated tube joint connection of claim 1, wherein the first tube end portion includes a male tube end.

5. The insulated tube joint connection of claim 1, wherein the first load transfer rim is substantially channel-shaped in cross section.

6. The insulated tube joint connection of claim 1, wherein the first load transfer rim has an arcuate cross section.

7. The insulated tube joint connection of claim 1, wherein the first load transfer rim has a tapering cross section.

8. The insulated tube joint connection of claim 1, wherein the first outer seal clamp seat extends radially outwardly from the tube end portion.

9. The insulated tube joint connection of claim 1, wherein the first outer seal clamp seat includes a resilient wall.

10. The insulated tube joint connection of claim 1, wherein the first outer seal clamp seat includes an annular wall defining a longitudinal groove for clamping movement between a partially clamped closed position and an unclamped open position.

11. The insulated tube joint connection of claim 1, and further comprising:
insulation disposed in the insulating space.

12. The insulated tube joint connection of claim 1, and further comprising:
a second tube defining a conduit and having a second tube end portion adjacent to the first tube end portion of the first tube;
a second load transfer rim joined to the second tube to at least partially define the second tube end portion; and
a second outer seal clamp seat joined to the second inner seal spacer and spaced radially outwardly from the second tube end portion to at least partially define a second insulating space.

13. The insulated tube joint connection of claim 12, and further comprising:
insulation disposed in the second insulating space.

14. The insulated tube joint connection of claim 12, wherein the first insulating space is open to the second insulating space to define a single insulating space.

15. The insulated tube joint connection of claim 12, wherein the first outer seal clamp seat is in mating contact with the second outer seal clamp seat.

16. The insulated tube joint connection of claim 12, wherein the first outer seal clamp seat includes a resilient wall for movement between a clamped position in contact with the second outer seal clamp seat, and an unclamped position.

17. The insulated tube joint connection of claim 12, wherein the second tube end portion is disposed for movement relative to the first tube end portion; and
the first outer seal clamp seat and the second outer seal clamp seat include complimentary ramp portions for movement between a clamped position and an unclamped position.

18. An insulated tube joint retrofitting connection comprising:
a first load transfer rim having a base portion to be joined to a first tube and disposed to at least partially define a first tube end portion; and
a first outer seal clamp seat joined to the first load transfer rim to at least partially define a first insulating space.

19. The insulated tube joint retrofitting connection of claim 18, wherein the first load transfer rim is substantially channel-shaped in cross section.

20. The insulated tube joint retrofitting connection of claim 18, wherein the first load transfer rim has an arcuate cross section.

21. The insulated tube joint retrofitting connection of claim 18, wherein the first load transfer rim has a tapering cross section.

22. The insulated tube joint retrofitting connection of claim 18, wherein the first outer seal clamp seat extends radially outwardly from the first load transfer rim base portion.

23. The insulated tube joint retrofitting connection of claim 18, wherein the first outer seal clamp seat includes a resilient wall.

24. The insulated tube joint retrofitting connection of claim 18, wherein the first outer seal clamp seat includes an annular wall defining a longitudinal groove for clamping movement between a partially clamped closed position and an unclamped open position.

25. The insulated tube joint retrofitting connection of claim 18, wherein the first outer seal clamp seat includes a spherical flange joint.
